(19) United States
(12) Patent Application Publication
(10) Pub. No.: US 2015/0049667 A1
(43) Pub. Date: Feb. 19, 2015

(54) USER EQUIPMENT AND DATA DESTINATION DETERMINING METHOD

(71) Applicant: FUJITSU LIMITED, Kawasaki-shi (JP)

(72) Inventors: Masaya ODA, Fukuoka (JP); Yuichiro Oishi, Fukuoka (JP); Yasuhiro Kawano, Fukuoka (JP); Masanobu Shigyo, Fukuoka (JP)

(21) Appl. No.: 14/327,285

(22) Filed: Jul. 9, 2014

(30) Foreign Application Priority Data
Aug. 15, 2013 (JP) 2013-168808

(51) Int. Cl. H04W 8/18

(52) U.S. Cl. CPC H04W 8/183
USPC 370/328

(57) ABSTRACT

User equipment includes a first communication entity that supports a transport layer protocol and a network layer protocol, and that transmits data a transmission source address of which is set to be a certain network layer address, to a network; and a second communication entity that supports the transport layer protocol and the network layer protocol, and that by commonly using the certain network layer address, is able to transmit the data the transmission source address of which is set to be the certain network layer address, to the network, wherein the second communication entity includes a storage device that stores a port number not being overlapping a port number which is used in the first communication entity, and a control device that performs determining processing which, when the received data does not include the port number, determines that the destination of the received data is the first communication entity.

### CROSS-REFERENCE TO RELATED APPLICATION

This application is based upon and claims the benefit of priority of the prior Japanese Patent Application No. 2013-168808, filed on Aug. 15, 2013, the entire contents of which are incorporated herein by reference.

### FIELD

The embodiments discussed herein are related to user equipment and a method of determining a destination of data.

### BACKGROUND

A mobile communication network is in a stage of a transition to all IPization that is entailed by the introduction of the IP multimedia subsystem (IMS) that is specified in 3rd Generation Partnership Project (3GPP). In the future, the introduction of voice over LTE (VoLTE) that performs voice IP communication over Long Term Evolution (LTE) is scheduled by multiple network operators.

In 3GPP, user equipment (UE) includes terminal equipment (TE) that controls an application function, a terminal adaptation (TA) that controls radio access, a mobile termination (MT) that performs access to a radio network.

In IMS, a session initiation protocol (SIP) that is specified in the Internet Engineering Task Force (IETF) is employed as a protocol for session control that performs starting-up of or disconnecting of voice communication. As a protocol configuration in a case of realizing IMS, generally, SIP is installed in TE in which a transmission control protocol/Internet protocol (TCP/IP) is installed.

On the other hand, voice control by an existing circuit switch (CS) is performed in TA. For this reason, it is considered that functions of performing voice control are unified (platform-made) by installing SIP and a TCP/IP stack in TA. In this case, an IMS application (TE) developer may easily have IMS mounted by using TA in which SIP and the TCP/IP stack are installed.

When TA in which the TCP/IP stack is installed is installed in UE that includes TE in which the TCP/IP stack is installed, the UE is configured in such a manner as to have TCP/IP stack doubly. In this configuration, if TA and TE perform communication independently of each other, for example, multiple packet data network (PDN) connections to which different IP addresses are allocated are established between UE and a network (NW).

As described above, when the configuration is employed in which the multiple PDN connections are established using the multiple IP addresses, there is a concern that this may lead to wasting a resource between UE and NW and making connection management within UE complicated. On the other hand, if the same PDN connection is shared by TE and TA, the following problem occurs.

That is, in some cases, port numbers, each of which is used in a protocol of a transport layer (TCP/UDP (user datagram protocol)) that is present in each of TA and TE, may overlap between TA and TE. In such cases, when TA and TE perform communication with the same communication party (with a single apparatus that has a certain IP address), it is not possible to determine from the port number whether a destination of a packet received from the communication party is TA or TE.

Japanese Laid-open Patent Publication No. 2007-249472 is an example of the related art.

### SUMMARY

According to an aspect of the embodiments, user equipment includes: a first communication entity that supports a transport layer protocol and a network layer protocol, and that transmits data a transmission source address of which is set to be a certain network layer address, to a network; and a second communication entity that supports the transport layer protocol and the network layer protocol which are supported by the first communication entity, and that by commonly using the certain network layer address, is able to transmit the data the transmission source address of which is set to be the certain network layer address, to the network, wherein the second communication entity includes a storage device that stores a port number which is used when the second communication entity transmits data the transmission source address of which is set to be the certain network layer address, to the network, the port number not being overlapping a port number which is used in the first communication entity, and a control device that performs determining processing which, when the data received from the network, a destination address of which is set to be the certain network layer address includes a port number which is consistent with the port number which is stored in the storage device, determines that a destination of the received data is the second communication entity, and which, when the received data does not include the port number which is consistent with the port number which is stored in the storage device, determines that the destination of the received data is the first communication entity.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 schematically illustrates a configuration example of a network system according to an embodiment;

FIG. 2 illustrates a configuration example of UE hardware;

FIG. 3 is a block diagram illustrating a function of TE that is formed by performance of a program by a CPU that is included in TE and a function of TA that is formed by performance of a program by a CPU that is included in TA;

FIG. 4 is a sequence diagram illustrating an example of an operation that is performed when a PDN connection is established between TA and NW;

FIG. 5 illustrates an example of a data structure of a TA port management table (storage contents) managed by a TE port control unit;

FIG. 6 illustrates an example of a data structure of a port management table (storage contents) managed by a TA port control unit;

FIG. 7 is a sequence diagram illustrating an operation example in which starting of TCP/IP communication of an application of TA is set to be a trigger;

FIG. 8 illustrates a port management table that is updated by a TA port control unit;

FIG. 9 illustrates storage contents of the port management table that is managed by a TA-TE data overlapping avoidance control unit;

FIG. 10 illustrates a format example of an SIP packet (an IP packet);

FIG. 11 is a sequence diagram illustrating an example of an operation that is performed when a response packet of the SIP packet is received from NW (an application server);

FIG. 12 is a block diagram for describing an IP fragment;

FIG. 13 illustrates an example of a data structure of a fragment packet management table;

FIG. 14 is a flow chart illustrating processing in an avoidance control unit, in which the IP fragment is considered;

FIG. 15 is a block diagram for describing an operation according to the first embodiment;

FIG. 16 is a sequence diagram illustrating an operation example according to a second embodiment; and

FIG. 17 is a sequence diagram illustrating an operation example according to a third embodiment.

### DESCRIPTION OF EMBODIMENTS

Hereinafter, embodiments of the present disclosure are described referring to the drawings. A configuration of the embodiment is an example, and the embodiments are not limited to the configuration of the embodiment.

### First Embodiment

### Configuration Example of Network System

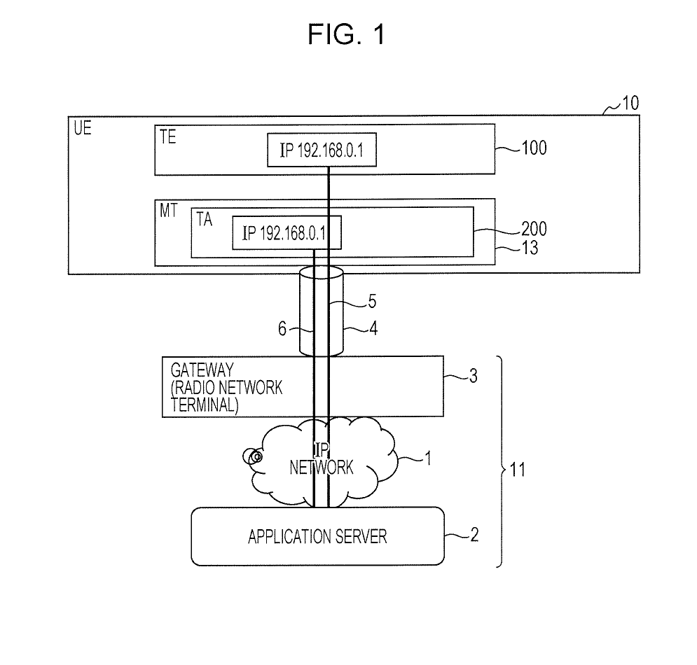

FIG. 1 schematically illustrates a configuration example of a network system according to an embodiment. The network system includes a network (NW) 11 and UE 10 that performs communication using the network.

In an example in FIG. 1, the network 11 includes an IP network 1, an application server 2 that is connected to the IP network 1, and a gateway 3 that is arranged between the IP network 1 and a radio network (a radio link). UE 10 is connected to the gateway 3 over the radio network, and may perform the communication with the application server 2 over the gateway 3 and the IP network 1.

UE 10 is one example of “user equipment.”. Furthermore, the IP network 1 is one example of the “network”, or of a “packet network”. The application server 2 is one example of the other communication parties. TE 11 is one example of a “first communication entity”, or of a “first communication apparatus” and TA 12 is one example of a “second communication entity”, or of a “second communication apparatus”.

UE 10 includes TE 100 that controls an application function, TA 200 that controls radio access, and MT 13 that performs access to the radio network. As illustrated in FIG. 1, TA 200 may be included in MT 13.

TE 100 performs TCP (including UDP)/IP communication with one (for example, the application server 2) of the other communication parties on the network in order to provide a service for TE, for example, a service relating to various applications that are included in TE 100. The TCP/IP communication is one example of a “packet communication”. The TCP/IP communication is hereinafter expressed briefly as “IP communication”.

On the other hand, TA 200 performs voice packet communication (for example, VoIP such as VoLTE) with one (for example, the application server 2) of the other parties on the network in order to provide various applications that are included in TA 200, for example, a communication call (a voice communication) service using SIP.

In order for each application of TE 100 and TA 200 to perform the IP communication, a TCP (including UDP)/IP protocol stack is installed in each of TE 100 and TA 200. That is, each of TE 100 and TA 200 supports the TCP (including UDP)/IP. TCP and UDP is one example of a “transport layer protocol that uses a port number”, IP is one example of a “network layer protocol”, and an IP address is one example of a “network layer address”.

If the IP communication (one example of the packet communication) is performed based on a certain application that is included in TA 200, a PDN connection is established between TA 200 and the other communication party. Among the multiple PDN connections that are possible to establish in TA 200, at least one PDN connection is commonly used (is shared) with TE 100. If a certain PDN connection is commonly used between TE 100 and TA 200, one common IP address is allocated to the PDN connection.

FIG. 1 illustrates a PDN connection 4 that is commonly used between TE 100 and TA 200, and an aspect in which on the PDN connection 4, while a packet flow 6 relating to the IP communication is formed between a certain application provided by TA 200 and the other communication party, a packet flow 5 relating to the IP communication is formed between a certain application of TE 100 and the other communication party. A common IP address (for example, 192.168.0.1) is used between TE 100 and TA 200 on the PDN connection 4.

For this reason, a transmission destination IP address of an IP packet that is received from the other communication party is the same IP address (192.168.0.1) both when the destination of the IP packet is TA 200 and when the destination of the IP packet is TE 100. In view of this, according to the embodiment, as described below, TA 200 has a TE-TA data overlapping avoidance control unit 206 and the TE-TA data overlapping avoidance control unit 206 terminates the downlink-side (NW→UE) PDN connection, determines which of TE 100 and TA 200 the IP network is destined to, and performs IP packet distribution according to a result of the determination.

Configuration of UE Hardware (HW)

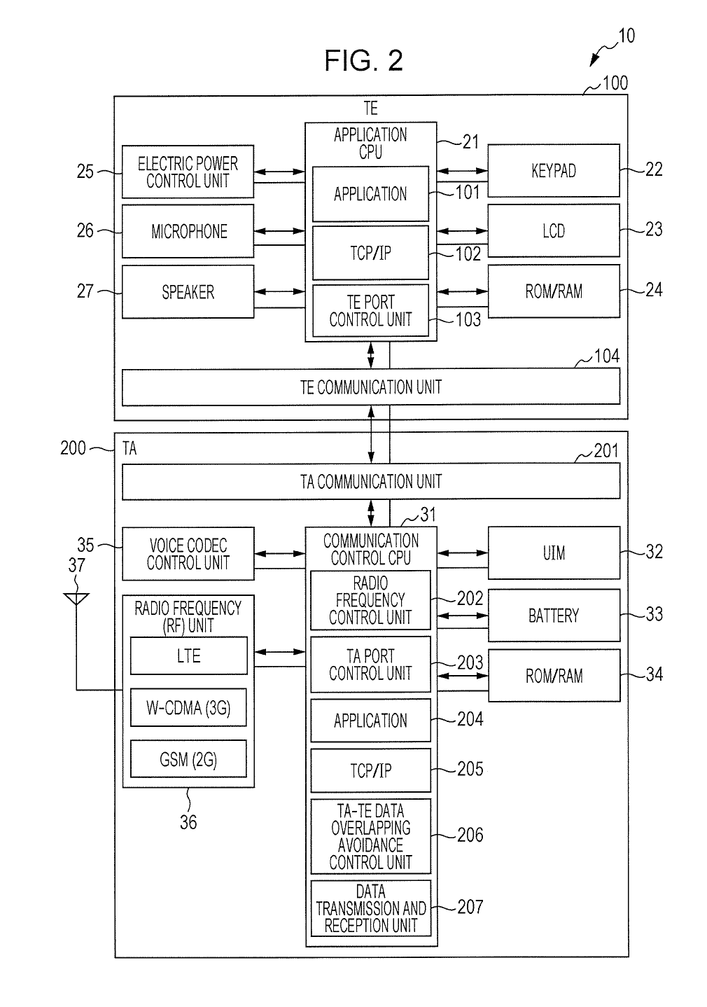

FIG. 2 is a configuration example of UE hardware 10. In FIG. 2, TE 100 includes an application central processing unit (CPU) 21 (hereinafter, referred to as a “CPU 21”), a keypad 22 that is connected to the CPU 21, a liquid crystal display (LCD) 23, a read only memory (ROM)/random access memory (RAM) 24, a power source control unit 25, a microphone 26, a speaker 27, and a TE communication unit 104. Constituent elements of TE 100, described above, are electrically connected to one another through internal wiring within UE 10.

The keypad 22 is used in order for a user (an operator) of UE 10 to input information. The keypad 22 is one example of an “input device”. Various pieces of information, such as information stored in UE 10 or information relating to a result obtained by performing a program, are displayed on the LCD 23. The LCD 23 is one example of a “display device”.

Various programs performed by the CPU 21 and data used when performing the programs are stored in the ROM/RAM 24. Furthermore, the ROM/RAM 24 is used as an operating region when the CPU 21 performs the programs. The ROM/RAM 24 is one example of a “storage device”, or a “computer-readable recording medium”.

The power source control unit 25 controls supplying of an electric power for operating the multiple constituent elements included in UE 10 and stopping of the supplying of the electric power. The power source control unit 25 may include an ON/OFF switch for the electric power that is operated by the operator of UE 10.

The microphone 26 is one example of a voice input device. The speaker 27 is one example of a voice output device. The microphone 26 and the speaker 27 are used when making a communication call (the voice communication) that uses UE 10. The TE communication unit 104 is a communication interface circuit, or a communication interface device for performing the communication with the TA communication unit 201 included in TA 200.

The CPU 21 performs processing relating to an application 101, and processing relating to a TCP/IP 102 by performing the program stored in the ROM/RAM 24. Moreover, the CPU 21 functions as a TE port control unit 103 by performing the program.

TA 200 includes a communication control CPU 31 (hereinafter briefly referred to as the “CPU 31”), a user identity module (UIM) card 32 connected to the CPU 31, a battery 33, a ROM/RAM 34, a voice CODEC control unit 35, a radio frequency (RF) unit 36, and the TA communication unit 201.

The UIM card 32 is an IC card in which information on a subscriber (a user) of UE 10 is stored. Instead of the UIM card 32, a subscriber identity module card (SIM) card may be used.

The battery 33 accumulates electric power that the power source control unit 25 is to supply to the constituent elements of UE 10. The various programs performed by the CPU 31 and data used when performing the programs are stored in the ROM/RAM 34. Furthermore, the ROM/RAM 34 is used as the operating region when the CPU 31 performs the programs. The ROM/RAM 34 is one example of the “storage device”, or the “computer-readable recording medium”.

When making a communication call using UE 10, the voice CODEC control unit 35 performs coding processing of a voice signal that is input from the microphone 26 or decoding processing of coded data that is received in an antenna 37.

A radio frequency unit 36 is a circuit, or a device for performing radio communication with the gateway 3 (FIG. 1), and performs DA conversion of a transmission-target baseband signal that is supplied from the CPU 31, up-conversion, modulation onto the radio frequency (RF), amplification processing, and the like. A radio frequency signal propagates from the antenna 37 and is received in the gateway 3 over a radio network 4. Furthermore, the radio frequency unit 36 supplies to the CPU 31 the baseband signal that is obtained by amplification of the radio frequency signal that is received in the antenna 37, down-conversion, AD conversion, and the like.

The radio frequency unit 36, for example, may perform processing according to at least one that is selected from among various radio access standards (radio communication methods), such as LTE, the wideband code division multiple access (W-CDMA: 3G), and the global system for mobile communications (GSM (a registered trademark): 2G). The TA communication unit 201 is the communication interface circuit or the communication interface device for performing the communication with the TE communication unit 104 of TE 100.

The CPU 31 function as a radio frequency control unit 202 and a TA port control unit 203 by performing the program that is stored in the ROM/RAM 34. Furthermore, the CPU 31 performs processing relating to an application 204 and processing relating to the TCP/IP 205 by performing the program. Moreover, the CPU 31 functions as the TA-TE data overlapping avoidance control unit (the avoidance control unit) 206 and a data transmission and reception unit 207 by performing the program.

Each of the CPU 21 and the CPU 31 that are described above are one example of a “processor”, and a “control device. Instead of each of the CPU 21 and the CPU 31, a digital signal processor (DSP) may be used. Furthermore, functions of each of the CPU 21 and the CPU 31 are possible to realize by a hardware logic (a wired logic) that uses an integrated circuit (an IC, an LSI, and an application specific integrated circuit (ASIC)). Furthermore, the functions of each of the CPU 21 and the CPU 31 are possible to realize by using a programmable logic device (PLD) such as a field programmable gate array (FPGA).

Configuration Example of UE Software (SW)

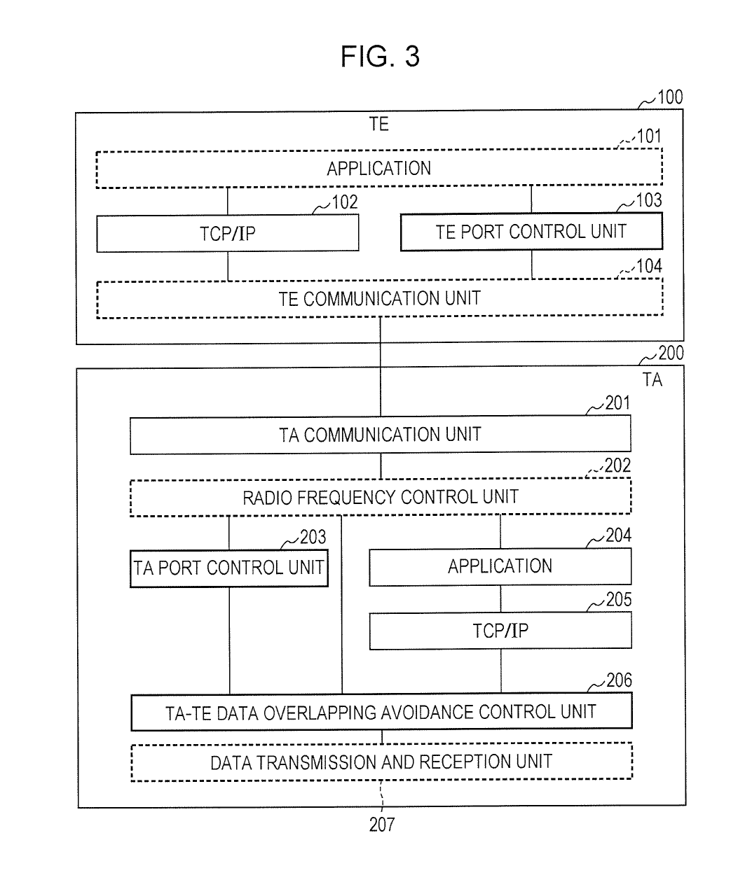

FIG. 3 is a block diagram illustrating a function of TE 100 that is formed by performance of the program by the CPU 21 and a function of TA 200 that is formed by performance of the program by the CPU 31.

TE 100 includes the application 101, the TCP/IP 102 and the TE port control unit 103 that are connected to the application 101, and the TE communication unit 104 that is connected to the TCP/IP 102 and the TE port control unit 103.

In TA 200, the TA communication unit 201 is connected to the TE communication unit 104, and the radio frequency control unit 202 is connected to the TA communication unit 201. Furthermore, the TA port control unit 203, the application 204, and the avoidance control unit 206 are connected to the radio frequency control unit 202. The TA port control unit 203 is connected to the avoidance control unit 206. The TCP/IP 205 is connected to the application 204, and the TCP/IP 205 is connected to the avoidance control unit 206. The avoidance control unit 206 is connected to the data transmission and reception unit 207.

In TE 100, the application 101 transmits to the TE port control unit 103 a message that is a “port number obtainment request”, which requests for obtainment of the port number that is used in TA 200. Furthermore, the application 101 transmits a message that is a “socket opening request”, which requests for opening a socket of the designated port, to the TCP/IP 102 and transmits the IP packet to NW 11.

The TCP/IP 102 notifies the application 101 of the IP packet that is received from the avoidance control unit 206. Furthermore, the TCP/IP 102 opens a TCP/UDP port that is designated according to the “socket opening request” from the application 101 and transmits the IP packet.

When receiving a “TA port number reservation request” from the radio frequency control unit 202 in TA 200, the TE port control unit 103 obtains and retains the ports the number of which corresponds to the number of the requested TCP/UDP ports. Furthermore, the TE port control unit 103 transmits to the radio frequency control unit 202 a message that is a “TA port number reservation response”, to which the port number in TA 200 is assigned.

Furthermore, when receiving the “port number obtainment request” from the application 101, the TE port control unit 103 transmits to the application 101 a “port number notification” in which the TCP/UDP port being used in TA 200 is assigned.

Furthermore, when receiving a “TA port number notification”, from the radio frequency control unit 202, the TE port control unit 103 retains a TCP/UDP port number that is notified. Furthermore, if a TA port number being notified is already used in TE 100, the TE port control unit 103 performs dispensing (allocating) of the substitute port number that has to be used in TA 200, and notifies the radio frequency control unit 202 of the port number that is dispensed with a message that is a “TA port number notification response”.

The TE communication unit 104 performs transmission and reception of the message between the TE communication unit 104 and TA 200 and notifies the TE port control unit 103, the TCP/UDP 102, or the like of the message from TA 200.

The TA communication unit 201 performs the transmission and reception of the message between the TA communication unit 201 and TE 100 and notifies the radio frequency control unit 202 or the like of the message from TE 100.

If TE 100 obtains the TCP/UDP port number, the radio frequency control unit 202 performs calculating of the number of the ports that are used in TA 200 and transmits to the TE port control unit 103 the message that is the “TA port number reservation request”, in which the number of desired ports is assigned. Furthermore, when receiving from the TE port control unit 103 the message that is the “TA port number reservation response”, the radio frequency control unit 202 notifies the TA port control unit 203 of the message that is the “TA port number notification”, in which the port number being notified from the TE 100 is assigned.

The radio frequency control unit 202 transmits to the TA port control unit 203 the message that is the “TA port number obtainment request” in order to obtain the port number that is used in transmitting the IP packet from TA 200. The radio frequency control unit 202 transmits to the application 204 a message that is an “IP packet transmission request”, by using the port the port number of which is notified by a message that is a “TA port number obtainment response”, which is received from the TA port control unit 203.

Moreover, if TA 200 obtains the TCP/UDP port number, the radio frequency control unit 202 performs calculating of the number of the TCP/UDP ports that are used in TA 200 and transmits to the TA port control unit 203 the message that is the “TA port number reservation request”. If the message that is the “TA port number reservation response” is received from the TA port control unit 203, the radio frequency control unit 202 transmits to the TE port control unit 103 the “TA port number notification” in which the port being notified with the “TA port number reservation response” is assigned. Furthermore, when receiving from the TE port control unit 103 the message that is the “TA port number notification response”, the radio frequency control unit 202 transmits the “TA port number notification” to the TA port control unit 203.

Furthermore, if the TCP/UDP port is dynamically obtained, which is triggered by the starting of the IP packet transmission by TA 200, the radio frequency control unit 202 transmits the “TA port number reservation request” to the TE port control unit 103 and receives the “TA port number reservation response” from the TE port control unit 103. The radio frequency control unit 202 transmits to the TA port control unit 203 a message that is a “TA port number instantaneousness use notification”, in which the port number being notified with the “TA port number reservation response” and an identifier of an in-use application are assigned.

When receiving from the radio frequency control unit 202 the message that is the “TA port number notification”, the TA port control unit 203 retains the TCP/UDP port number that is notified with the “TA port number notification”. Furthermore, when receiving the “TA port number obtainment request” from the radio frequency control unit 202, the TA port control unit 203 dispenses the port not in use, among the retained port numbers, transmits to the radio frequency control unit 202 the message that is the “TA port number obtainment response”, in which the dispensed port number (the port number that has to be used in TA 200) is assigned and transmits the “TA port number notification” to the avoidance control unit 206.

If TA 200 determines the TCP/UDP port number, when receiving the “TA port number reservation request” from the radio frequency control unit 202, the TA port control unit 203 obtains and retains as many port numbers as desired, which are used in TA 200. Then, the TA port control unit 203 notifies the TE port control unit 103 of the message that is the “TA port number reservation response”, in which the obtained port number is assigned.

When receiving the “TA port number instantaneousness use notification” from the radio frequency control unit 202, the TA port control unit 203 retains the TCP/UDP port number that is notified with the “TA port number instantaneousness use notification” and transmits the “TA port number notification” to the avoidance control unit 206.

When receiving the message that is the “IP packet transmission request” from the radio frequency control unit 202, the application 204 transmits the designated “socket opening request” and thereafter transmits the IP packet, to the TCP/IP 205. Furthermore, when receiving the IP packet from NW 11 (the other communication party), the application 204 receives the IP packet from the TCP/IP 205 and performs processing according to a service.

The TCP/IP 205 opens the TCP/UDP port that is designated with the “socket opening request” from the application 204 and transmits the IP packet. Furthermore, the TCP/IP 205 notifies the application 204 of the IP packet that is received from the avoidance control unit 206.

The avoidance control unit 206 may perform managing in a manner that distinguishes between the PDN connection that is commonly used between TE 100 (the application 101) and TA 200 (the application 204) and the PDN connections other than the PDN connection being commonly used. The avoidance control unit 206 has a function of terminating the PDN connection being commonly used, and when receiving the IP packet in which a PDN address being commonly used is set as a transmission destination address, determines which of TE 100 and TA 200 the IP packet is destined to, by terminating the IP packet. If the destination is TE 100, the avoidance control unit 206 transmits the packet toward the application 101 of TE 100, and if the destination is TA 200, the avoidance control unit 206 transmits the IP packet toward a predetermined application that is included in the application 204 of TA 200.

When receiving the “TA port number notification” from the TA port control unit 203, the avoidance control unit 206 performs retaining (storing) of the TCP/UDP port number being notified. Furthermore, when receiving the IP packet from NW 11 (the other communication party), the avoidance control unit 206 checks a transmission destination port number of the received IP packet. If the transmission destination port number is consistent with the retained port number, the avoidance control unit 206 transmits the IP packet to the TCP/IP 205 and if the transmission destination port number is not consistent with the retained port number, transmits the IP packet to the TA communication unit 201.

The data transmission and reception unit 207 performs transmitting and receiving of the baseband signal between the data transmission and reception unit 207 and the radio frequency unit 36. That is, the data transmission and reception unit 207 generates the baseband signal by performing the coding processing and modulation processing on the data that has to be transmitted to NW 11, and supplies the generated baseband signal to the radio frequency unit 36. On the other hand, the data transmission and reception unit 207 obtains the data that is transmitted from NW 11, by performing demodulation processing and the decoding processing on the baseband signal that is received from the radio frequency unit 36.

When a PDN connection establishment notification is received from NW, the data transmission and reception unit 207 transmits the PDN connection establishment notification to the radio frequency control unit 202. Furthermore, the data transmission and reception unit 207 performs the transmitting and receiving of the IP packet. If the IP packet is received from NW 11, the data transmission and reception unit 207 transmits the IP packet to the avoidance control unit 206.

Operation Example

Next, an operation example of UE 10 and the network that are described above are described. FIG. 1 illustrates a configuration of the PDN connection between UE 10 and NW 11 according to the first embodiment.

When one PDN connection is established between UE 10 and NW 11, a certain IP address is allocated, as the PDN address, to the PDN connection. UE 10 uses the PDN address in the TCP/IP communication that uses the PDN connection. That is, if the IP packet is transmitted from UE 10 to NW 11 using the PDN connection, the PDN address is desirably set in a transmission source address of the IP packet. Furthermore, if UE 10 receives the IP packet from NW 11 through the PDN connection, the PDN address is set as the transmission destination address of the IP packet.

As the application 101 of TE 100, for example, a general user application program, such as a Web browser or a mailer, is assumed. On the other hand, as the application 204 of TA 200, for example, an application for controlling SIP and the like in VoLTE or VoIP is assumed. However, types of application programs (an application 101 and an application 102) are not limited to the applications described above. Furthermore, the number of the applications that are performed in each of TE 100 and TA 200 is an arbitrary number that is 1 or greater.

According to the first embodiment, both of the application 101 of TE 100 and the application 204 of TA 200 use the same (common) PDN connection. For example, the PDN connection that is used by SIP, one of the applications included in the application 204, is commonly used with the PDN connection that is used by a certain application of TE 100. At this time, for example, the IP address, “192.168.0.1”, is used as the IP address (the PDN address) that is allocated to the common PDN connection 4. In other words, the PDN address that is used by a certain application of TE 100 and the PDN address that is used by SIP of TA 200 are the same (common) “192.168.0.1”.

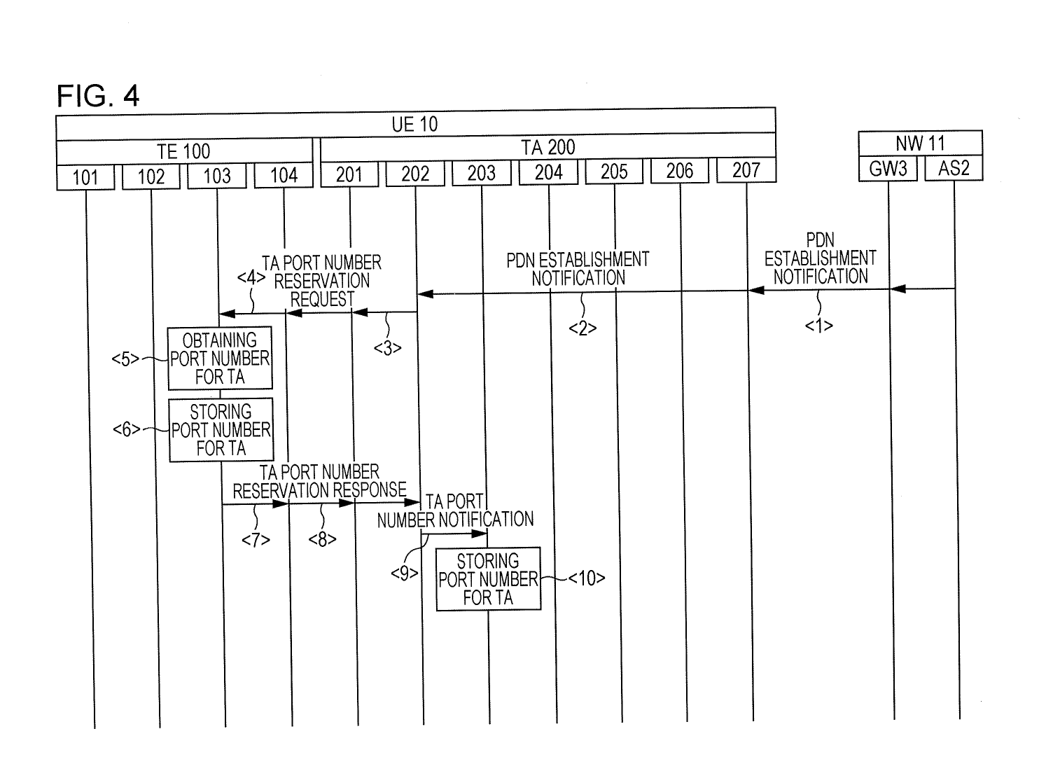

FIG. 4 is a sequence diagram illustrating an example of an operation that is performed when the PDN connection (for example, the PDN connection 4 in FIG. 1) is established between TA 200 and NW 11. For example, if the PDN connection for SIP of TA 200 is established, TE 100 requests TA 200 to establish the PDN connection for SIP. In TA 200, according to the request, the PDN connection is established between TA 200 (SIP) and the gateway 3 by performing a procedure (a negotiation) for establishing the PDN connection with the other communication party (for example, the application server 2 that is when the application server 2 is a SIP server).

At this time, an identifier (for example, a bearer number) of the PDN connection is provided from NW 11. The identifier is received in TA 200 and TE 100. Accordingly, thereafter, in TE 100, when an application starts that commonly uses the PDN connection with SIP, TE 100 recognizes that the PDN connection is already established, based on the identifier, and the application may perform the IP communication with the other communication party (the application server 2) using the PDN connection. Conversely, if before starting SIP, the application of TE 100 that is commonly used with SIP establishes the common PDN connection that is commonly used, information that the PDN connection ends up being established is transferred to TA 200, and the information transfer may be regarded as the establishing of the common PDN connection by SIP (the TA side application).

Moreover, SIP is an example of the TA application that commonly uses the PDN connection with the application of TE 100 and may be applications other than SIP. The number of the PDN connections that are commonly used between TE 100 and TA 200 is not limited to 1. Furthermore, a ratio of the number of the TE side applications to the number of the TA side applications relating to the PDN connection that is commonly used may be 1:N or N:1 (N is a natural number).

A procedure that is invoked after as an example of SIP, one of the applications 204, the PDN connection for SIP (that is, the PDN connection being commonly used) is established at the TA 200 side is described below referring to FIG. 4. In FIG. 4, when the PDN connection is established, the data transmission and reception unit 207 receives a PDN establishment notification from NW 11 (<1> in FIG. 4). The PDN address “192.168.0.1” is included in the PDN establishment notification. The identifier of the PDN connection described above is included in that PDN establishment notification, is transferred between the TA side (for example, the avoidance control unit 206) and the TE side, and is managed at both sides.

The data transmission and reception unit 207 transmits to the radio frequency control unit 202 the PDN establishment notification that is received from NW 11 (<2> in FIG. 4). The radio frequency control unit 202 receives the PDN establishment notification. From this point onward, TE 100 and TA 200 are in a state where the IP packet that uses the PDN connection (the PDN connection 4 in FIG. 1) that is commonly used is possible to transmit and receive.

The radio frequency control unit 202 retains in advance a total number of the TCP/UDP ports that are used in the TCP/IP communication. The total number of the TCP/UDP ports is stored in advance in the ROM/RAM 34 (FIG. 2). The radio frequency control unit 202 that receives the PDN establishment notification transmits the “TA port number reservation request” to TE 100 (<3> in FIG. 4). For example, if the 10 applications 204 of TA 200 are present, the “number of the reserved ports=10” is set in the TA port number reservation request. The TA port number reservation request from the radio frequency control unit 202 is notified to the TE port control unit 103 through the TA communication unit 201 and the TE communication unit 104 (<4> in FIG. 4).

The TE port control unit 103 that receives the TA port number reservation request dispenses the port numbers the number of which is the number of the reserved ports that is set in the TA port number reservation request (<5> in FIG. 4). The multiple port numbers that are available for the TCP/IP communication is pooled (stored) in the ROM/RAM 24 (FIG. 2), and a pool (not illustrated) of the port numbers is managed by the TE port control unit 103. The port number that is dispensed to TE 100 and TA 200 is selected from the pool of the port numbers. Therefore, TE 100 and TA 200 use the same port number system.

The TE port control unit 103 may perform dispensing by reading from the pool of the port numbers the port number not in use, the number of which is the number of the reserved ports. The TE port control unit 103 stores the port number that is dispensed to a TA port management table 41 (<6> in FIG. 4).

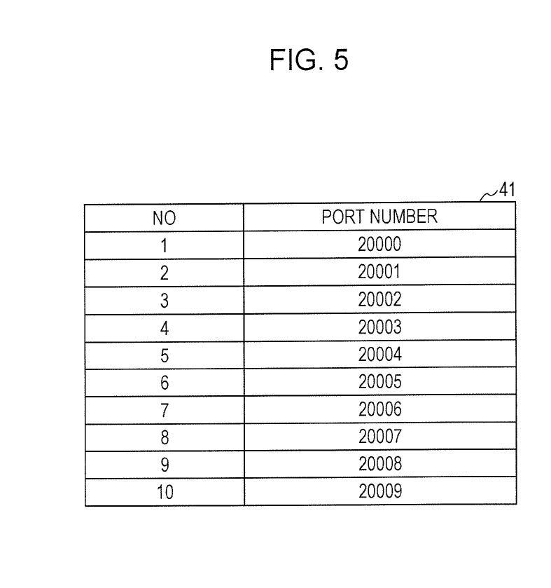

FIG. 5 illustrates an example of a data structure of the TA port management table 41 (storage contents). The TA port management table 41 is stored in the ROM/RAM 24 and is managed (read and written) by the TE port control unit 103. The port number that is dispensed for TA 200 is written to the TA port management table 41 by the TE port control unit 103. In an example in FIG. 5, the port numbers “20000 to 20009” are stored, as the port numbers (the port numbers that end up being reserved) that are dispensed to TA 200.

The TE port control unit 103 generates the TA port number reservation response that includes the port numbers “20000 to 20009” that end up being reserved and transmits the generated TA port number reservation response to TA 200 (<7> in FIG. 4). The TA port number reservation response is received by the radio frequency control unit 202 through the TE communication unit 104 and the TA communication unit 201 (<8> in FIG. 4).

When receiving the TA port number reservation response, the radio frequency control unit 202 transmits to the TA port control unit 203 the TA port number notification that includes the port number the ends up being reserved (<9> in FIG. 4). When receiving the TA port number notification, the TA port control unit 203 stores the port number that ends up being reserved, which is dispensed from TE 100, in a port management table 42 that is stored in the ROM/RAM 34 (<10> in FIG. 4).

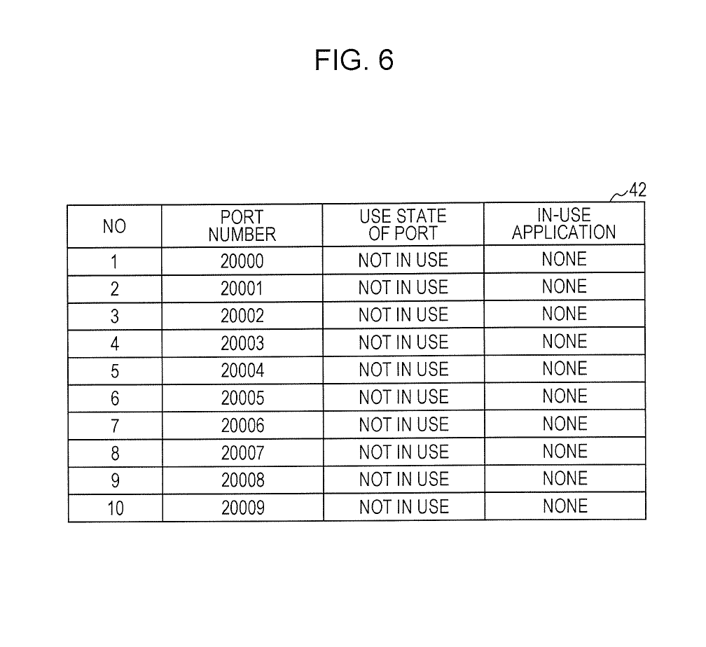

FIG. 6 is illustrates an example of a data structure of the port management table 42 (storage contents). The port management table 42 is made from one or more entries that store a port number, a use state of the port that corresponds to the port number, and an identifier (identification information) of the application 204 that uses the port number. The port management table 42 is managed (read and written) by the TA port control unit 203.

A point in time at which the TA port number notification is received, because the TCP/IP communication does not yet start, as illustrated in FIG. 6, the use states of all the port numbers that are stored in (registered with) the port management table 42 are set to “not in use”. Furthermore, the in-use applications are all set to “none”.

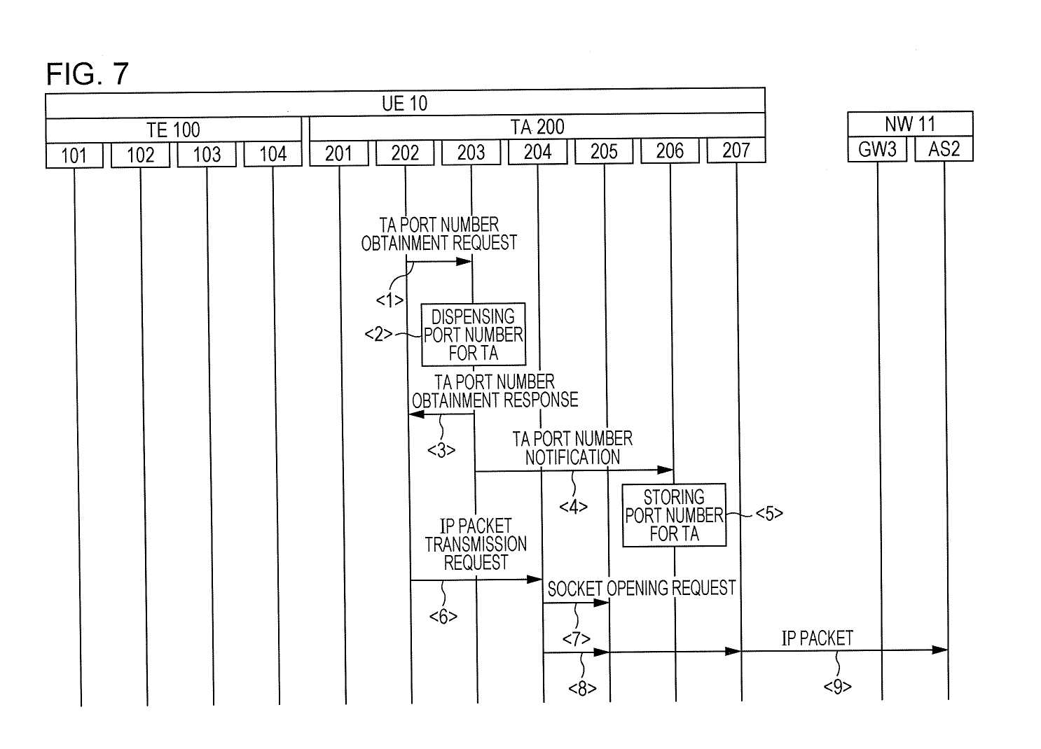

FIG. 7 is a sequence diagram illustrating an operation example in which the starting of the TCP/IP communication of the application 204 of TA 200 is set to be a trigger. The radio frequency control unit 202 transmits the TA port number obtainment request to the TA port control unit 203, which is triggered by the starting of the TCP/IP communication (<1> in FIG. 7). Information (an identifier) indicating the in-use application is set in the TA port number obtainment request. For example, at the time of the starting of a VoLTE service, user registering that uses SIP is performed. In such a case, information indicating “SIP” as the application 204 being used is set in the TA port number obtainment request.

When receiving the TA port number obtainment request, the TA port control unit 203 performs the dispensing of a port for TA (<2> in FIG. 7). That is, the TA port control unit 203 searches the TA port management table 42 (FIG. 6) for the port number not in use and determines the port number that is used in the application 204 (SIP) of TA 200.

For example, if the storage contents of the port management table 42 is in a state illustrated in FIG. 6, all the ports are in a not-in-use state. In such a case, the TA port control unit 203 determines the top port number “20000” as the port number to use in SIP. If the port number “20000” is used by another application 204, that is, if the port use state of the port number “20000” is an “in-use” state, the TA port control unit 203 selects another port number the port use state of which is the “not-in-use state. A rule for selecting and determining the port number is that the port number may be selected when it is properly suitable, and the port number may be determined in ascending order, in descending order, or at random, from the port management table 42.

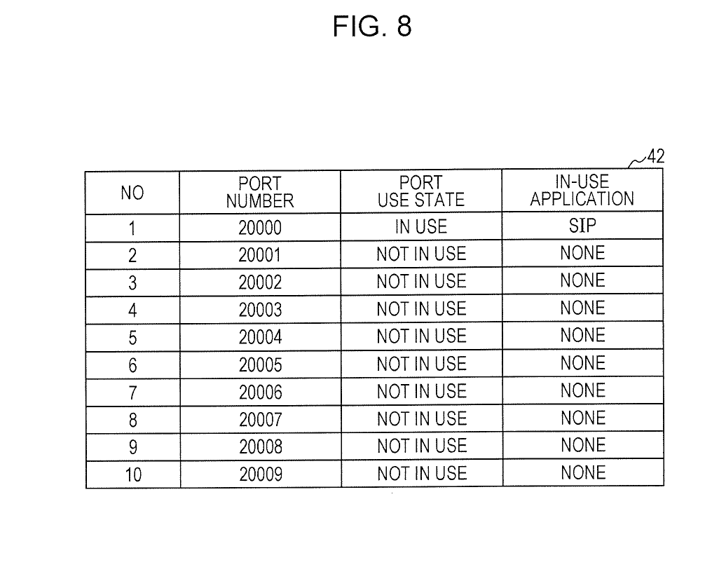

The TA port control unit 203 sets the port use state of the port number “20000” to “in-use”, and sets the in-use application to “SIP”. FIG. 8 illustrates the port management table 42 that is updated. Subsequently, the TA port control unit 203 generates the message that is the TA port number obtainment response, in which the “port number=20000” is set, and transmits the generated message to the radio frequency control unit 202 (<3> in FIG. 7).

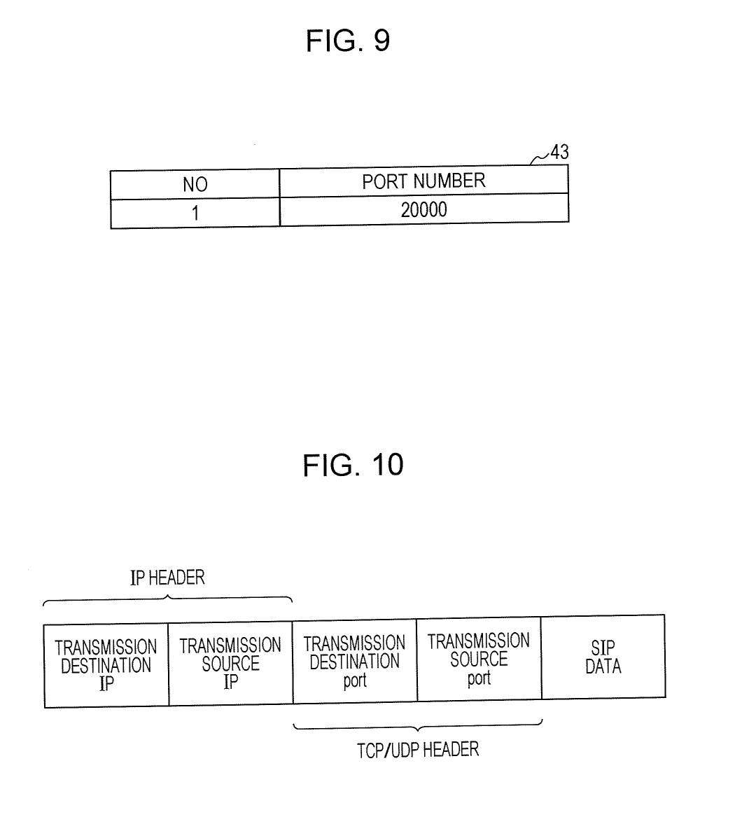

Furthermore, the TA port control unit 203 transmits to the avoidance control unit 206 the TA port number notification, in which the “port number=20000” is set (<4> in FIG. 7). When receiving the TA port number notification, the avoidance control unit 206 stores in a port management table 43 the port number “20000” that is notified to the port management table 43 (<5> in FIG. 7). FIG. 9 illustrates storage contents of the port management table 43.

When receiving the TA port number obtainment response, the radio frequency control unit 202 transmits to the application 204 of TA 200 the IP packet transmission request in which the “port number=20000” is set (<6> in FIG. 7). The application 204 transmits a socket opening request to the TCP/IP 205 (<7> in FIG. 7) and starts the TCP/IP communication (<8> in FIG. 7) by using the port number “20000” that is set in the IP packet transmission request. Accordingly, a SIP packet in which the transmission source address “192.168.0.1” and a transmission source port number “20000” are set is transmitted to NW 11 through the data transmission and reception unit 207 (<9> in FIG. 7).

The SIP packet is one example of the IP packet. FIG. 10 illustrates a format of the SIP packet (the IP packet). In NW 11, the SIP packet reaches the application server (AS) 2 that is the other communication party, through the gateway (GW) 3 and the IP network 1.

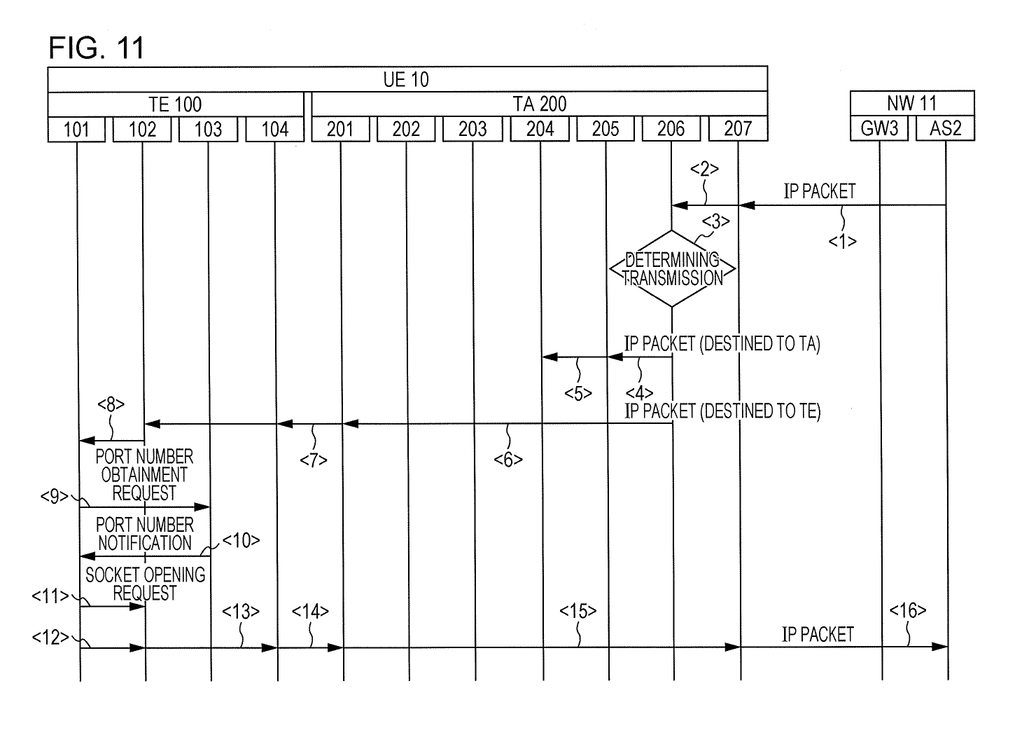

FIG. 11 is a sequence diagram illustrating an example of an operation that is performed when a response packet of the SIP packet is received from NW 11 (the application server 2). In FIG. 11, when receiving the SIP packet, the application server (AS) 2 performs processing, based on the SIP packet and then generates the response packet of the SIP packet. The response packet has the format illustrated in FIG. 10. However, the PDN address “192.168.0.1” is set in the transmission destination address of the response packet. Furthermore, the port number “20000” is set in the transmission destination port number of the response packet. The response packet is one example of the IP packet.

The response packet (the IP packet) that is transmitted from the application server 2 is received in UE 10 through the gateway 3 and reaches the data transmission and reception unit 207 (<1> in FIG. 11). The data transmission and reception unit 207 transmits the received IP packet to the avoidance control unit 206 (<2> in FIG. 11).

The avoidance control unit 206 performs transmission determining processing that determines whether a transmission destination of the received IP packet is TA 200 or TE 100 (<3> in FIG. 11). That is, the avoidance control unit 206 determines whether or not the transmission destination port number of the IP packet is the port number that is stored in the port management table 43 (FIG. 9).

If the port number that is consistent with the transmission destination port number is stored in the port management table 43, the avoidance control unit 206 regards the IP packet as being destined to the application 204 and transmits the IP packet to the application 204 through the TCP/IP 205 (<4> and <5> in FIG. 11). The application 204 performs desired processing using data that is included in the IP packet.

In contrast, if the port number that is consistent with the transmission destination port number is not present in the port management table 43, the avoidance control unit 206 regards the IP packet as being destined to the application 101 of TE 100 and transmits the IP packet to the TA communication unit 201 (<6> in FIG. 11). The IP packet is transmitted to the TE communication unit 104 (<7> in FIG. 11) and reaches the application 101 through the TCP/IP 102 (<8> in FIG. 11). The application 101 performs desired processing using data that is included in the IP packet.

As described above, the TCP/IP communication is possible in which the application 204 of TA 200 and the application 101 of TE 100 uses one common PDN connection.

On the other hand, the application 101 of TE 100 uses the port number other than the port number that is dispensed to TA 200, in the TCP/IP communication. In order to avoid overlapping with the port number that is used in TA 200, the application 101 of TE 100 transmits the port number obtainment request to the TE port control unit 103 (<9> in FIG. 11).

When receiving the port number obtainment request, the TE port control unit 103 transmits to the application 101 the port number notification that includes the port number stored in the TA port management table 41 (FIG. 5) (<10> in FIG. 11). The application 101 selects the port number (for example, “20010”) other than the port number that is included in the port number notification, from the pool of the port numbers, and starts the TCP/IP communication using the selected port number.

That is, the application 101 transmits the socket opening request to the TCP/IP 102 (<11> in FIG. 11), and transmits the IP packet (the destination IP address: the IP address of AS 2) in which the transmission source IP address “192.168.0.1” is set and the selected port number “20010” is set in the transmission source port number (<12> in FIG. 11). The IP packet is transmitted from TE 100 to TA 200 (<13> and <14> in FIG. 11) and is transmitted from TA 200 to NW 11 (<15> and <16> in FIG. 11). In NW 11, the IP packet reaches AS 2 through GW 3.

Fragment of IP Packet

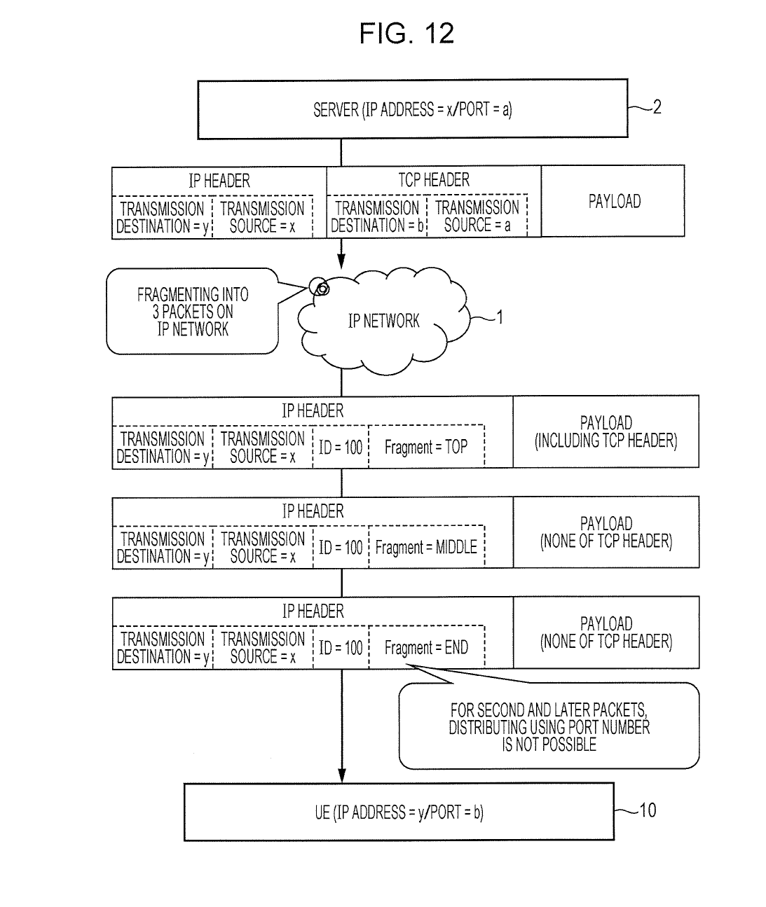

In the operation example described above, the avoidance control unit 206 considers fragmentation (also referred to as an IP fragment) of the IP packet. FIG. 12 is a diagram for describing the IP fragment. In FIG. 12, a TCP/UDP header (a TCP header in FIG. 12) and an IP header are added to the IP packet that is destined from the application server 2 (hereinafter referred to as the server 2) to UE 10.

If relayed on the IP network 1, such an IP packet is divided (fragmented) into multiple IP packets depending on a payload length. This division is referred to as the IP fragment. Each of the multiple IP packets that results from the division are referred to as an IP fragment packet. The IP packet is one example of “data”, and the IP fragment packet is one example of “data fragment”.

In an example in FIG. 12, the IP packet that is transmitted from the server 2 is divided (fragmented) into 3 IP fragment packets by the fragmentation. An ID (ID=100 in FIG. 12) for identifying the fragment packet and an identifier indicating the “top”, the “middle”, or the “end” fragment are set in the IP header of each IP fragment packet. With the ID, it may be determined that the multiple IP fragment packets having the same ID are generated from one IP packet. The ID and the identifier are used when the IP fragment packets are assembled into the original IP packet (referred to as defragmentation).

In the IP fragment, a payload of the original IP packet is divided into multiple fragments and the IP header including the ID and the identifier of the fragment that are described above is assigned to each fragment. At this time, the TCP header that is assigned to the original IP packet is handled as one portion of the payload. As a result, normally, the TCP header is included only in the top IP fragment packet and is not included in the second or later IP fragment packets.

However, as described above, the avoidance control unit 206 distributes the IP packets to TA 200 and TE 100, depending on the transmission destination port number that is included in the IP packet. If UE 10 receives the second or later IP fragment packets, it is not possible to determine whether the destination of the IP packet other than the top fragment is the application 204 of TA 200 or the application 101 of TE 100.

For this reason, the avoidance control unit 206 has the following configuration. That is, a fragment packet management table 44 is stored in the ROM/RAM 34 and the avoidance control unit 206 performs managing and referring on the fragment packet management table 44.

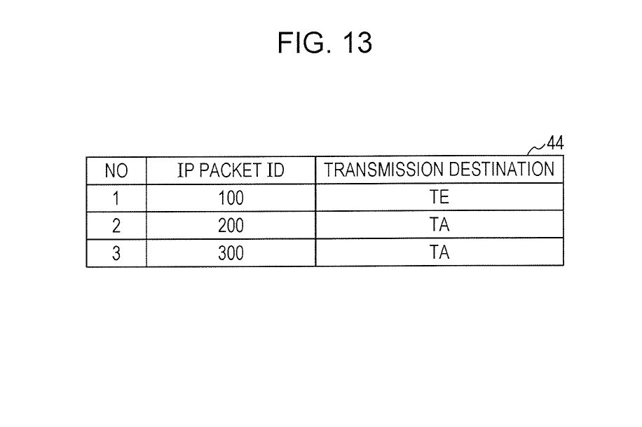

FIG. 13 illustrates an example of a data structure of a fragment packet management table. The fragment packet management table 44 is made from an ID of an IP fragment packet and at least one or more entries that stores a distribution destination (TE/TA).

As described above, a common ID is set in an ID field within the IP header of a group of the IP fragment packets that are generated by IP fragment. Therefore, it is possible to apply a result of performing distributing on the top IP fragment packet to the group of the IP packets that has the common ID.

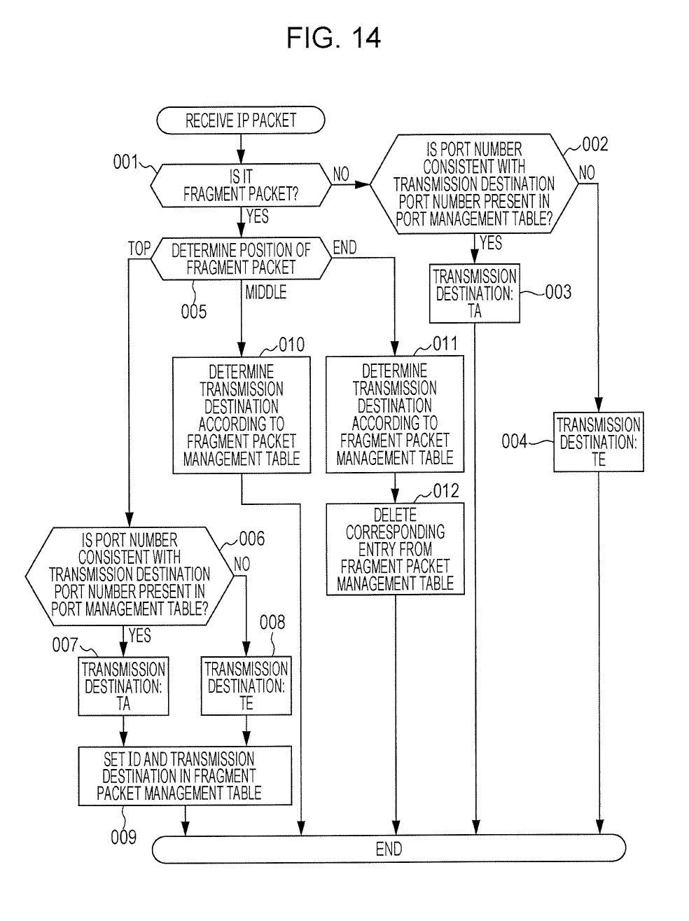

FIG. 14 is a flow chart illustrating processing in the avoidance control unit 206, in which the IP fragment is considered. The processing in FIG. 14 starts by the avoidance control unit 206 receiving the IP packet. The avoidance control unit 206 determines whether or not the received IP packet is the IP fragment packet (001). If the IP packet is not the IP fragment packet (NO in 001), the processing proceeds to 002. In contrast, if the IP packet is the IP fragment packet (YES in 001), the processing proceeds to 005.

In 002, the avoidance control unit 206 determines whether or not the port number that is consistent with the transmission destination port number of the IP packet is stored in the port management table 43 (FIG. 9). At this time, if the port number that is consistent with a transmission port number is stored (YES in 002), the avoidance control unit 206 determines that a transmission destination of the IP packet is TA 200 and performs transmission processing (003). On the other hand, if the port number that is consistent with the transmission port number is not stored (NO in 002), the avoidance control unit 206 determines that the transmission destination of the IP packet is TE 100 and performs the transmission processing (004). After 003 and 004 are ended, the avoidance control unit 206 ends the processing.

If the processing proceeds to 005, that is, if the IP fragment packet is received, the avoidance control unit 206 performs position determining by referring to the identifier of the fragment that is set in the IP header of the IP fragment packet. At this time, if the identifier of the fragment indicates the “top”, the processing proceeds to 006. If the identifier of the fragment indicates the “middle”, the processing proceeds to 010. If the identifier of the fragment indicates the “end”, the processing proceeds to 011.

If the processing proceeds to 006, that is, if the IP fragment packet is the top packet, the avoidance control unit 206 performs the same processing as in 002, 003, and 004. That is, the avoidance control unit 206 determines whether or not the port number that is consistent with the transmission destination port number of the IP packet is stored in the port management table 43. And if the port number being consistent is stored (YES in 006), the avoidance control unit 206 determines that the transmission destination of the IP packet is TA 200 and performs the transmission processing (007). On the other hand, if the port number that is consistent with the transmission port number is not stored (NO in 006), the avoidance control unit 206 determines that the transmission destination of the IP packet is TE 100 and performs the transmission processing (008). In this manner, the distributing to TE 100 or TA 200 is performed on the top IP fragment packet using the header of a transport protocol (TCP/UDP).

After the processing in 007 and the processing in 008 are ended, processing in 009 is performed. In 009, the avoidance control unit 206 saves a result of the distribution in the fragment packet management table 44 (FIG. 13). That is, the avoidance control unit 206 stores in the fragment packet management table 44 the entry that includes the ID of the IP fragment packet and information (TE or TA) indicating the transmission destination of the IP fragment packet. Thereafter, the avoidance control unit 206 ends the processing.

If the processing proceeds to 010, that is, if the middle IP fragment packet is received, the avoidance control unit 206 refers to the fragment packet management table 44 (FIG. 13), reads the transmission destination that is stored in the entry in which the ID consistent with the ID included in the IP fragment packet is stored, and determines the transmission destination being read, as the transmission destination of the IP fragment packet. Then, the avoidance control unit 206 transmits the IP fragment packet to the determined transmission destination (TA or TE) and ends the processing.

In this manner, the avoidance control unit 206 that receives the IP fragment packet that is not the top IP fragment packet performs searching of the fragment packet management table 44 for the IP fragment packet ID. If the entry, the ID of which is consistent, hits, the avoidance control unit 206 transmits the IP packet to the distribution destination, that is, the application (the application 204 or the application 101), which corresponds to the ID.

If the processing proceeds to 011, that is, if the end IP fragment packet is received, the avoidance control unit 206 refers to the fragment packet management table 44 (FIG. 13), reads the transmission destination that is stored in the entry in which the ID consistent with the ID included in the IP fragment packet is stored, and determines the transmission destination being read as the transmission destination of the IP fragment packet. Then, the avoidance control unit 206 transmits the IP fragment packet to the determined transmission destination (TA or TE). The processing in 011 is the same as in 010.

Subsequently, the avoidance control unit 206 deletes the entry that hits in 011, from the fragment packet management table 44 (012) and ends the processing. In this manner, when receiving the end IP fragment packet, after performing the distributing of the IP fragment packet, the avoidance control unit 206 deletes from the fragment packet management table 44 the entry in which the ID of the IP fragment packet is stored. As described above, it is possible to perform the distributing to TE/TA also on the IP fragment packet.

Effects According to First Embodiment

According to the first embodiment, in the user equipment (UE 10) in which a TCP/IP stack is installed in each of TE 100 and TA 200, the port number that is used in TE 100 and TA 200 is determined in advance. Accordingly, the overlapping use of the same port number in TE 100 and TA 200 may be avoided.

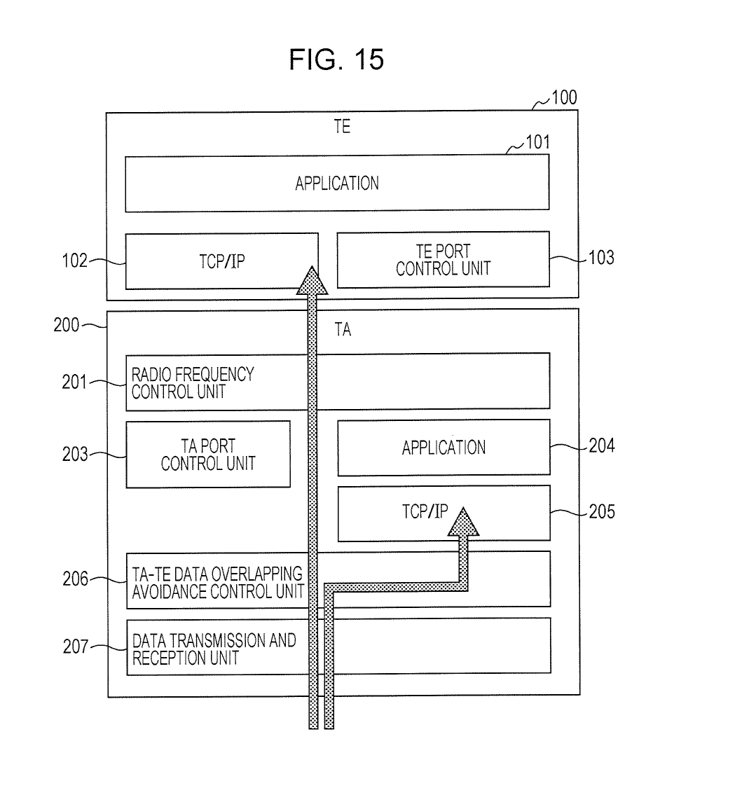

As a result, as illustrated in FIG. 15, at the time of the receiving of the IP packet of UE 10, the IP packet is properly distributed to one of TE 100 and TA 200 by the possessing by the avoidance control unit 206 illustrated in FIG. 14. Therefore, even though the TCP/IP communication with the other communication parties (for example, the server 2) that are the same is performed using one PDN connection, TE 100 and TA 200 may transmit and receive the IP packets that are independent of each other.

Furthermore, according to the first embodiment, the number of the PDN connections established between UE 10 and NW 11 may be reduced.

### Second Embodiment

Next, a second embodiment is described. Because the second embodiment has features in common with the first embodiment, differences between them are mainly described and descriptions of the features in common are omitted. The second embodiment is different from the first embodiment in that the TA port control unit 203 itself performs the port number that is used by TA 200 and notifies the TE port control unit 103 of the obtained port number.

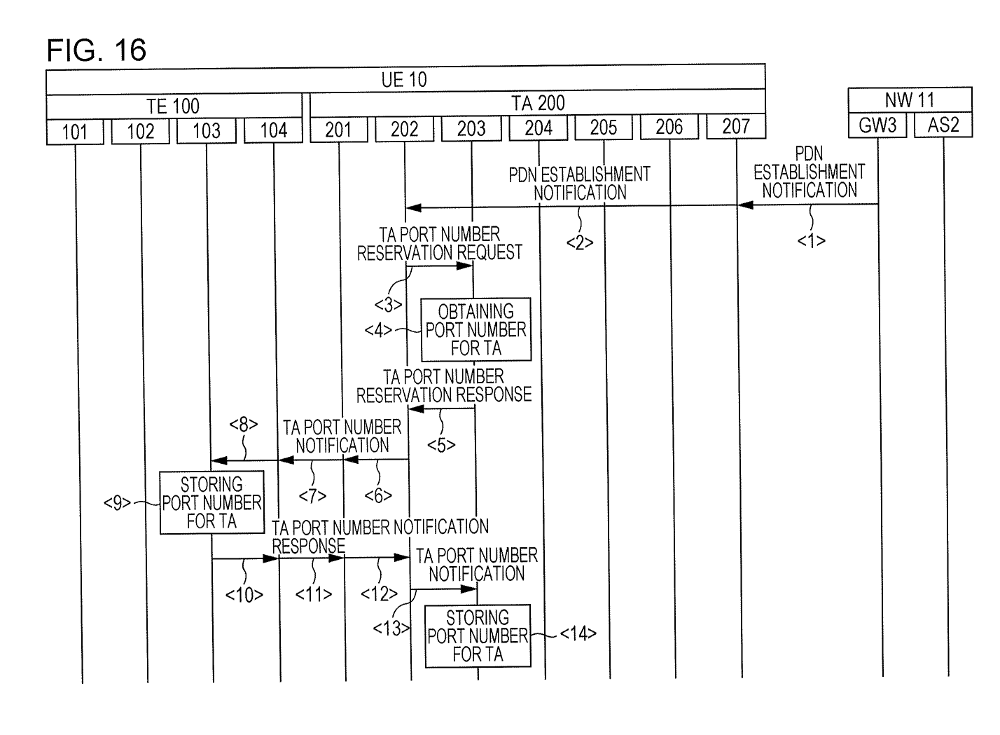

FIG. 16 is a sequence diagram illustrating an operation example according to the second embodiment. FIG. 16 is the sequence diagram illustrating an operation example that results when the PDN connection is established between TA 200 and NW 11. In FIG. 16, when the PDN connection is established between TA 200 and NW 11 (the server 2) (refer to FIG. 3), the data transmission and reception unit 207 receives the PDN establishment notification from NW 11 (<1> in FIG. 16). The PDN address “192.168.0.1” is included in the PDN establishment notification.

The data transmission and reception unit 207 transmits to the radio frequency control unit 202 the PDN establishment notification that is received from NW 11 (<2> in FIG. 16). When receiving the PDN establishment notification from the data transmission and reception unit 207, the radio frequency control unit 202 notifies the TA port control unit 203 of the TA port number reservation request (<3> in FIG. 16). For example, if the 10 applications 204 of TA 200 are present, the number of the reserved ports “10” is set in the TA port number reservation request.

Unlike in the first embodiment, the TA port control unit 203 refers to information (which is stored in advance in the ROM/RAM 34) on the port number that is available for TCP/UDP communication. The TA port control unit 203 selects (obtains) the port numbers (for example, “20000 to 20009”, and hereinafter referred to as a “group of the port numbers”) of which the number is the number of the reserved ports (<4> in FIG. 16).

Subsequently, the TA port control unit 203 generates the TA port number reservation response that includes the obtained group of the port numbers “20000 to 20009” and transmits the generated TA port number reservation response to the radio frequency control unit 202 (<5> in FIG. 16).

The radio frequency control unit 202 that receives the TA port number reservation response generates and transmits the TA port number notification that includes the group of the port numbers “20000 to 20009” (<6> in FIG. 16). The TA port number notification is transmitted from the TA communication unit 201 to the TE communication unit 104 (<7> in FIG. 16) and is sent from the TE communication unit 104 to the TE port control unit 103 (<8> in FIG. 16).

The TE port control unit 103 that receives the TA port number notification stores a port number for TA in the TA port management table 41 (FIG. 5) (<9> in FIG. 16). At this point, if some of or all of the port numbers in the group that are included in the TA port number notification are already used by the application 101 of TE 100, the port number may not be used in TA 200.

For this reason, the TE port control unit 103 performs the following processing. As described according to the first embodiment, whether each port number is in use or is not in use (the presence or absence of the dispensing) is stored in the pool of the port numbers that is stored in the ROM/RAM 34. When storing the port number in the port management table 41, the TE port control unit 103 refers to the pool of the port numbers and determines whether each port number that is included in the group of the port numbers that is notified from TA 200 is in use or is not in use.

The TE port control unit 103 stores in the port management table 41 the port number not in use. In contrast, if the port number in use is found in the group of the port numbers, the TE port control unit 103 refers to the pool of the port numbers, dispenses the port number not in use (referred to as a “substitute port number”), different from the port number in use, and stores the port number to the port management table 41. For example, if the port number “20009” is in use, the port number “20010” not in use is dispensed as the substitute port number, from the pool.

Thereafter, the TE port control unit 103 generates and transmits the TA port number notification response that includes the group of the port numbers (the entire group of the port numbers (for example: 20000 to 20009) that is notified from TA 200, or some of the port numbers in the group that is notified from TA 200 and the substitute port numbers (for example: 20000 to 20008, and 20010)) that is stored in the port management table 41 (<10> in FIG. 16). Accordingly, with one-time exchange between TA 200 and TE 100, TA 200 may obtain the port numbers the number of which, TA 200 hopes, is reserved (dispensed).

The TA port number notification response is transmitted from the TE communication unit 104 to the TA communication unit 201 (<11> in FIG. 16) and reaches the radio frequency control unit 202 through the TA communication unit 201 (<12> in FIG. 16).

The radio frequency control unit 202 generates the TA port number notification that includes the group of the port numbers that is included in the TA port number notification response and transmits the generated TA port number notification to the TA port control unit 203 (<13> in FIG. 16). When receiving the TA port number notification, the TA port control unit 203 stores the port number for TA (the group of the port numbers that is notified from the TE 100) in the TA port management table 42 (FIG. 6) (<14> in FIG. 16).

Thereafter, when the IP packet is transmitted from the radio frequency control unit 202, the TA port number obtainment request to the TA port control unit 203 is performed. The subsequent operations are the same as the operations according to the first embodiment (refer to FIGS. 7 and 11). For this reason, descriptions of the subsequent operations are omitted.

Also with the operations described according to the second embodiment, the port number (the group of the port numbers) that is used by TA 200 may be registered in advance.

### Third Embodiment

Next, a third embodiment is described. Because the third embodiment has features in common with the first embodiment, differences between them are mainly described and descriptions of the features in common are omitted. According to the first and second embodiments, the radio frequency control unit 202 collectively obtains the TCP/UDP port numbers that are used in TA 200 at the timing when the PDN connection is established. According to the third embodiment, instead of the configuration described above, by being triggered by the new starting of the TCP/IP communication by each of the applications 204 of TA 200, the port number for the application is obtained. That is, the port number is obtained at any time.

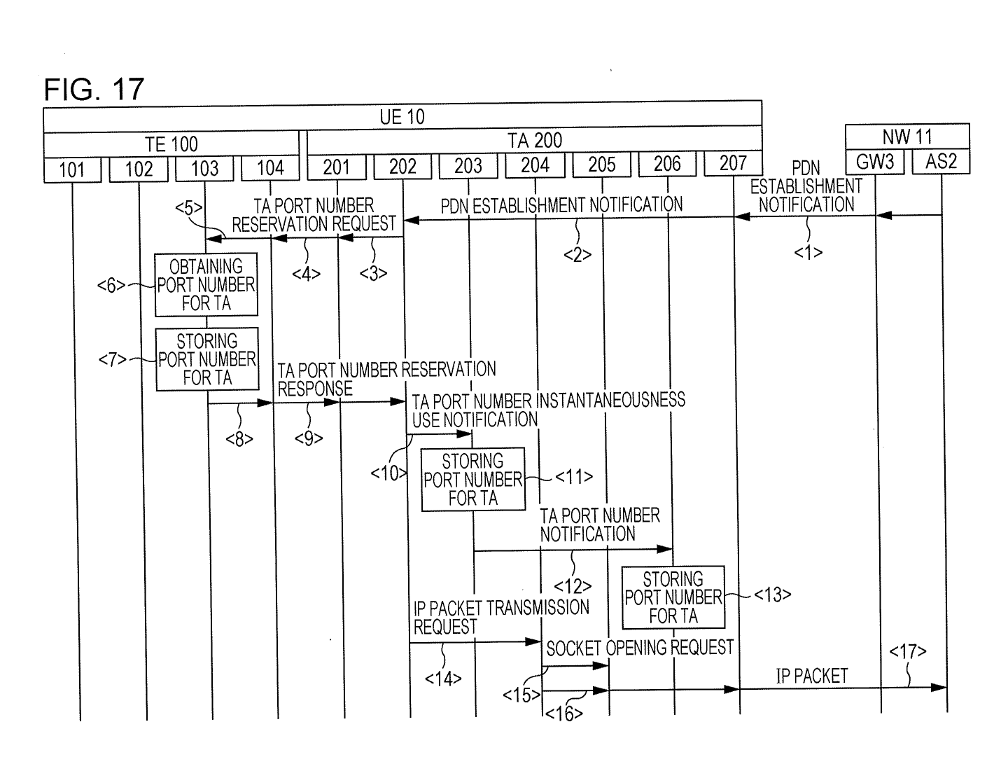

FIG. 17 is a sequence diagram illustrating an operation example according to the third embodiment. As illustrated in FIG. 17, by establishing the PDN connection, the PDN establishment notification is transmitted from NW 11 (<1> in FIG. 17) and is received in the radio frequency control unit 202 of TA 200. At this point, the radio frequency control unit 202 does not start an operation of obtaining the TCP/UDP port number.

Thereafter, by being triggered by the new starting of the TCP/IP communication by a certain application (example, SIP) that is included in the application 204 of TA 200, the radio frequency control unit 202 transmits the TA port number reservation request (<3> in FIG. 17). According to the third embodiment, the TA port number reservation request is transmitted to obtain the port number at which a certain application (SIP) may perform the TCP/IP communication. For this reason, the number of the reserved ports that is set in the TA port number reservation request is 1 for SIP.

The TA port number reservation request is transmitted from the TA communication unit 201 to the TE communication unit 104 (<4> in FIG. 17) and is received in the TE port control unit 103 (<5> in FIG. 17). The TE port control unit 103 refers to the pool of the port numbers and the TA port management table 41, and dispenses one port number (for example, “20000”) that is not in use in TE 100 and TA 200, from the pool (<6> in FIG. 17). Subsequently, the TE port control unit 103 stores the dispended port number “20000” in the TA port management table 41 (FIG. 5) (<7> in FIG. 17).

The TE port control unit 103 generates and transmits the TA port number reservation response that includes the dispensed port number “20000” (<8> in FIG. 17). The TA port number reservation response is transmitted from the TE communication unit 104 to the TA communication unit 201 (<9> in FIG. 17) and is received in the radio frequency control unit 202 (<10> in FIG. 17).

When receiving the TA port number reservation response, the radio frequency control unit 202 transmits to the TA port control unit 203 the TA port number instantaneousness use notification in which the identifier of the application (SIP) to use and the port number “20000” for the application to use are set (<10> in FIG. 17).

When receiving the TA port number instantaneousness use notification, the TA port control unit 203 resisters the port number and the identifier of the application with the TA port management table 42 (<11> in FIG. 17). Referring to the example described above, in the TA port number instantaneousness use notification, “SIP” as the identifier of the application (a name of the application), and the entry that if the port number “20000” is not included, includes “port number ‘20000,’ “in use”, and “SIP” are registered with the TA port management table 42.

A data structure of the TA port management table 42 is the same as the data structure illustrated in FIG. 8, but at this point, is such that only No. 1 entry illustrated in FIG. 8 is stored and No. 2 and later entries are not present. In this manner, according to the third embodiment, the port number is dispensed at every TA port number reservation request.

Thereafter, the TA port control unit 203 transmits the TA port number notification to the avoidance control unit 206 (<12> in FIG. 17). Because operations subsequent to <13> illustrated in FIG. 17 are the same as the operations subsequent to <5> illustrated according to the first embodiment (in FIG. 7) and descriptions thereof are omitted. Furthermore, because operation of the avoidance control unit 206 on the IP packet from NW 11 is also the same as the operation according to the first embodiment (refer to FIG. 11), a description thereof is omitted.

Like according to the third embodiment, each time the application starts the TCP/IP communication in TA 200, the port number that is used by the application may be dispensed from TE. The configurations according to the first to third embodiments are possible to combine suitably.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. User equipment comprising:
a first communication entity that supports a transport layer protocol and a network layer protocol, and that transmits data a transmission source address of which is set to be a certain network layer address, to a network; and
a second communication entity that supports the transport layer protocol and the network layer protocol which are supported by the first communication entity, and that by commonly using the certain network layer address, is able to transmit the data the transmission source address of which is set to be the certain network layer address, to the network,
wherein the second communication entity includes
a storage device that stores a port number which is used when the second communication entity transmits data the transmission source address of which is set to be the certain network layer address, to the network, the port number not being overlapping a port number which is used in the first communication entity, and
a control device that performs determining processing which, when the data received from the network, a destination address of which is set to be the certain network layer address includes a port number which is consistent with the port number which is stored in the storage device, determines that a destination of the received data is the second communication entity, and which, when the received data does not include the port number which is consistent with the port number which is stored in the storage device, determines that the destination of the received data is the first communication entity.

2. The user equipment according to claim 1,
wherein when a connection to the network is established, the control device performs
processing that requests the first communication entity to dispense one or more port numbers which are used in the second communication entity,
processing that stores in the storage device one or more port numbers not in use which are dispensed by the first communication entity according to the request,
processing that, when the second communication entity starts data communication which transmits data the transmission source address of which is set to be the certain network layer address, to the network, selects from the one or more port numbers a port number which is used in the data communication, and
processing that stores the selected port number, as a port number which is used in the determining processing, in the storage device.

3. The user equipment according to claim 2,
wherein in the requesting processing, the control device performs
processing that transmits to the first communication entity a request message including the number of the port numbers which are used in the second communication entity, and receives from the first communication entity a response message including the port numbers the number of which is the number of the port numbers which are selected in the first communication entity according to the request message.

4. The user equipment according to claim 2,
wherein in the requesting processing, the control device performs
processing that transmits to the first communication entity a request message including at least one port number which is desired to be dispensed for use in the second communication entity, and receives from the first communication entity a response message including the at least one port number which is dispensed by the first communication entity according to the request message.

5. The user equipment according to claim 4,
wherein when the at least one port number is used in the first communication entity, the control device receives from the first communication entity a response message including a substitute port number that is a port number dispensed by the first communication entity to substitute for the at least one port number.

6. The user equipment according to claim 1,
wherein when data transmission is started in which the data the transmission source address of which is set to be the certain network layer address is transmitted to the network, the control device performs
processing that requests the first communication entity to dispense a port number which is used in the data transmission, and
processing that stores a port number not in use which is dispensed by the first communication entity according to the request, as a port number which is used in the data transmission and a port number which is used in the determining processing, in the storage device.

7. The user equipment according to claim 1,
wherein when the received data is a top data fragment, among multiple data fragments that have a common identifier, and that are generated by performing fragmentation on data which is destined to the user equipment, the control device performs
the determining processing using a port number that is included in the top data fragment,
processing that stores in the storage device the identifier which is included in the top data fragment, with a result of the determining processing being associated with the identifier, and
when the identifier stored in the storage device is included in data that is received thereafter, determining a destination of the data using the result of the determining processing that is stored associated with the identifier.

8. A method of determining a destination of data that is received in user equipment that includes a first communication entity that supports a transport layer protocol and a network layer protocol, and that transmits data a transmission source address of which is set to be a certain network layer address, to a network, and a second communication entity that supports the transport layer protocol and the network layer protocol which are supported by the first communication entity, and that by commonly using the certain network layer address, is able to transmit the data the transmission source address of which is set to be the certain network layer address, to the network, the method comprising:
causing a control device included in the second communication entity to store a port number that is used when the second communication entity transmits data the transmission source address of which is set to be the certain network layer address, to the network, the port number not being overlap a port number that is used in the first communication entity; and
causing the control device to perform determining processing that, when data received from the network, a destination address of which is set to be the certain network layer address includes a port number that is consistent with the port number that is stored in the storage device, determines that a destination of the received data is the second communication entity, and which, when the received data does not include the port number that is consistent with the port number that is stored in the storage device, determines that the destination of the received data is the first communication entity.
